(19) United States
(12) Patent Application Publication
(10) Pub. No.: US 2026/0251009 A1
(43) Pub. Date: Aug. 27, 2026

(54) FENESTRATION UNIT WITH FRAME CORNER MEMBER HAVING INTEGRALLY ATTACHED DEFORMABLE MEMBER

(71) Applicant: JELD-WEN, Inc., Charlotte, NC (US)

(72) Inventor: Shane Michael Meyer, Klamath Falls, OR (US)

(73) Assignee: JELD-WEN, Inc., Charlotte, NC (US)

(21) Appl. No.: 19/065,075

(22) Filed: Feb. 27, 2025

(51) Int. Cl. E06B 3/96; E06B 3/30

(52) U.S. Cl. CPC E06B 3/9616; E06B 3/30

(57) ABSTRACT

A fenestration unit frame includes a first elongate member, a second elongate member, and a corner member that is attached to the first elongate member and the second elongate member at a corner of the fenestration unit frame. The corner member includes a base and a deformable member that are integrally attached. The deformable member overlies at least part of the base. The base is more rigid than the deformable member, and the deformable member is compressed between the rigid base and at least one of the first elongate member and the second elongate member to provide a seal therebetween.

### TECHNICAL FIELD

The following generally relates to a fenestration unit and, more particularly, relates to a fenestration unit with a frame corner member having an integrally attached deformable member.

### BACKGROUND

A fenestration unit, such as a window, may include a frame that supports one or more other components of the unit. For example, the fenestration unit may include a frame that supports a panel (i.e., sash) therein. Typically, the frame is assembled from a plurality of elongate parts, and respective ends of these elongate parts are joined at corner joints.

However, it may be difficult, time consuming, labor intensive, etc. to join components of the frame. Also, it may be particularly challenging, costly, etc. to provide the frame with needed seals that protect against water intrusion into the frame. For example, flowable sealant may be injected into the frame and then cured to seal off one or more cavities therein; however, this process may be messy, possibly wasteful, and may be disadvantageously variable.

Accordingly, it is desirable to provide a fenestration unit with a high-performance frame with robust seals. It is also desirable to provide a method of manufacturing a fenestration frame that is highly efficient and that provides a high degree of repeatability. Furthermore, other desirable features and characteristics of the present disclosure will become apparent from the subsequent detailed description and the appended claims, taken in conjunction with the accompanying drawings and the foregoing technical field and background.

### SUMMARY

According to various embodiments, a fenestration unit frame is disclosed that includes a first elongate member, a second elongate member, and a corner member that is attached to the first elongate member and the second elongate member at a corner of the frame. The corner member includes a base and a deformable member that are integrally attached. The deformable member overlies at least part of the base. The base is more rigid than the deformable member, and the deformable member is compressed between the rigid base and at least one of the first elongate member and the second elongate member to provide a seal therebetween.

According to additional embodiments, a method of manufacturing a fenestration unit frame is disclosed. The method includes providing a corner member including a base and a deformable member that are integrally attached. The deformable member overlies at least part of the base, and the base is more rigid than the deformable member. Moreover, the method includes attaching the corner member to a first elongate member and to a second elongate member at a corner of the fenestration unit frame. The method further includes compressing the deformable member between the rigid base and at least one of the first elongate member and the second elongate member to provide a seal therebetween.

Moreover, according to various embodiments, a fenestration unit is disclosed that includes a frame and a panel supported within the frame. The frame includes a first elongate member with a first core frame member and a first cladding member. Furthermore, the frame includes a second elongate member with a second core frame member and a second cladding member. Also, the frame includes a corner member that is attached to the first elongate member and the second elongate member at a corner of the frame. The corner member includes a base and a deformable member that are integrally attached. The deformable member overlies at least part of the base on a first face of the corner member and on a second face of the corner member. The base is more rigid than the deformable member. The deformable member at the first face is compressed between the rigid base and the first core frame member to provide a first seal therebetween. The deformable member at the second face is compressed between the rigid base and the second core frame member to provide a second seal therebetween. The corner member includes an expansion plug defined by the deformable member and a selector feature defined by the base. The expansion plug is received within a first cavity of the first cladding member, and the selector feature is configured to selectively vary pressure against the expansion plug for substantially sealing within the first cavity. Additionally, the corner member includes a projection that is received in a second cavity of the second cladding member.

### BRIEF DESCRIPTION OF DRAWINGS

The exemplary embodiments will hereinafter be described in conjunction with the following drawing figures, wherein like numerals denote like elements, and wherein:

FIG. 1 is a perspective view of a fenestration unit according to various embodiments of the present disclosure;

FIG. 2 is a cross-sectional view of the fenestration unit of FIG. 1 according to example embodiments of the present disclosure;

FIG. 3 is a detail front view of the fenestration unit of FIG. 1;

FIG. 4 is a lower, rear perspective view of a corner of the fenestration unit of FIG. 1;

FIG. 5 is a perspective cross-sectional view of a corner joint of a frame of the fenestration unit of FIG. 1;

FIG. 6 is a perspective view of a corner member of the fenestration unit of FIG. 1 according to example embodiments of the present disclosure;

FIG. 7 is an exploded perspective view of a portion of the frame of the fenestration unit of FIG. 1, including the corner member of FIG. 6 and a first elongate member of the frame;

FIG. 8 is an assembled perspective view of the portion of the frame of FIG. 7;

FIG. 9 is a perspective section view of the corner joint of the frame of the fenestration unit of FIG. 1; and

FIG. 10 is a perspective section view of the corner joint of the frame of the fenestration unit of FIG. 1.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. In addition, those skilled in the art will appreciate that embodiments of the present disclosure may be practiced in conjunction with a variety of fenestration units, including but not limited to the embodiments discussed herein. Further, it should be noted that many alternative or additional functional relationships or physical connections may be present in an embodiment of the present disclosure. In addition, while the figures shown herein depict an example with certain arrangements of elements, additional intervening elements, devices, features, or components may be present in an actual embodiment. It should also be understood that the drawings are merely illustrative and may not be drawn to scale.

According to various embodiments of the present disclosure, a fenestration unit is disclosed that includes a frame with a corner member configured for joining a first elongate member of the frame to a second elongate member of the frame. In some embodiments, the frame may be configured to support a panel (e.g., a window sash) therein. The corner member may include a base and a deformable member, which are integrally attached. The deformable member may have a soft durometer (e.g., Shore A value of 0 to 70 or Shore 00 value of 10 to 90), and the base may be significantly more rigid and strong. The deformable member may serve as a gasket providing a mechanical seal at the respective interface. More specifically, the deformable member may be deformed and compressed between the base and the respective one of the first and second elongate members to define a seal therebetween. In some embodiments, the deformable member and the base may be co-molded together to define a unitary part. The deformable member may be used instead of a flowable sealant and may provide various manufacturing advantages.

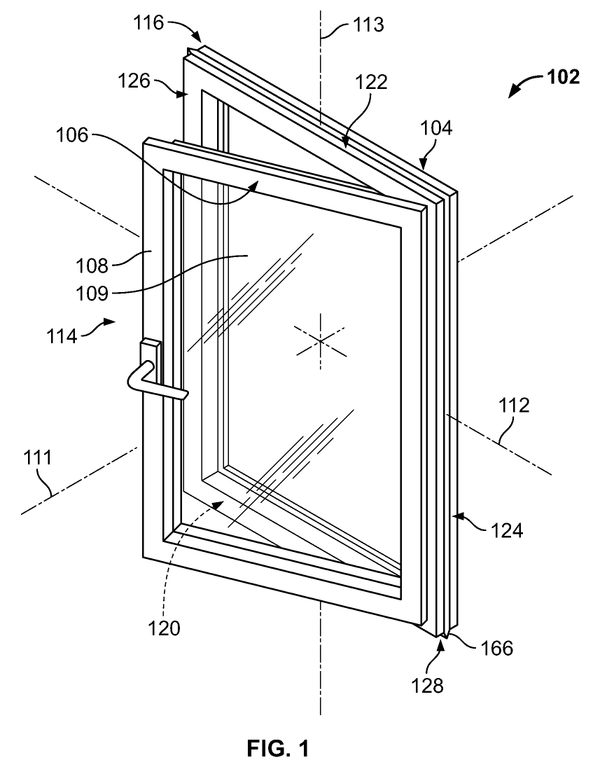

Referring initially to FIG. 1, a fenestration unit 102 is illustrated according to example embodiments. In this example, the fenestration unit 102 is a window; however, it will be appreciated that the teachings discussed herein may be applicable to other types of fenestration units, including, but not limited to doors, patio doors, sidelites, etc. The fenestration unit 102 may generally include a frame 104 and a panel 106 (i.e., sash) that is supported by the frame 104.

In some embodiments, the frame 104 may be rectangular so as to define a Cartesian coordinate system with a first axis 111, a second axis 112, and a third axis 113. The first axis 111 may extend between a first side 114 (i.e., an exterior side) and a second side 116 (i.e., an interior side) of the fenestration unit 102. In some embodiments, the fenestration unit 102 may be oriented on a wall, building, or other structure such that the first axis 111 extends horizontally between an exterior and interior of the structure. Moreover, the second axis 112 of the fenestration unit 102 may extend perpendicular to the first axis 111 and transversely across the fenestration unit 102, for example, in a horizontal direction between opposing sides of the fenestration unit 102. Additionally, the third axis 113 of the fenestration unit 102 may extend perpendicular to the first axis 111 and second axis 112, for example, in a vertical direction between opposing ends of the fenestration unit 102.

The panel 106 may be a rectangular window sash with a sash frame 108 that supports at least one pane 109 therein. The panel 106 may be supported by the frame 104 for movement between an open position and a closed position. As represented in FIG. 1, the panel 106 may be supported for rotational movement relative to the frame about an axis that is parallel to the third axis 113. In the open position represented in FIG. 1, the panel 106 may be pivoted outward from the first side 114 (i.e., the exterior side), and in the closed position, the panel 106 may be substantially co-planar with the frame 104 so as to share the first, second, and third axes 111, 112, 113 therewith.

The frame 104 may include a plurality of elongate members, each with a length dimension significantly greater than height and thickness dimensions thereof. The elongate members may include a sill member 120 and a header member 122, which are elongated to extend longitudinally substantially parallel to the second axis 112, and which are spaced apart along the third axis 113. The elongate members of the frame 104 may also include a first jamb 124 and a second jamb 126, which are elongated to extend longitudinally substantially parallel to the third axis 113, and which are spaced apart along the second axis 112.

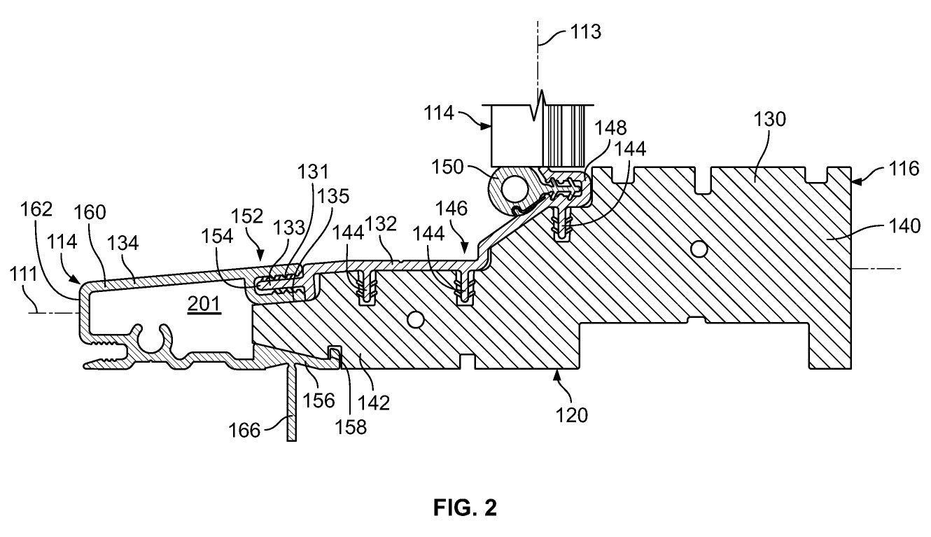

FIG. 2 represents a cross section of at least one of these elongate members of the frame 104 and, in some embodiments, may represent a cross section of each of the elongate members. Here, FIG. 2 will be discussed in relation to the sill member 120, but it will be appreciated that the header member 122, the first jamb 124, and/or the second jamb 126 may include corresponding features.

As represented in FIG. 2, the frame 104 may be a clad (i.e., cladded) frame 104 with a core frame member 130, a cover member 132, and a cladding member 134. The cross-sectional profiles of the core frame member 130, the cover member 132, and the cladding member 134 shown in FIG. 2 may be substantially continuous along the longitudinal length (extending along the second axis 112).

The core frame member 130 may include a solid cross section with an inner side 140 and an outer side 142, which are spaced apart along the first axis 111. The core frame member 130 may be strong and substantially rigid. In some embodiments, the core frame member 130 may be constructed from and/or include a wood-based material, and the core frame member 130 may be milled or otherwise constructed to have a plurality of surface features, such as grooves, stepped surfaces, channels, holes, kerfs, notches, etc.

The cover member 132 may be thin and plate-like and may have a substantially constant wall thickness. The cover member 132 may be constructed from a strong, polymeric material, such as vinyl. Also, in some embodiments, the cover member 132 may be an extruded part formed via an extrusion process. The cover member 132 may be attached to and may cover over a portion of the core frame member 130. For example, the cover member 132 may be layered over the core frame member 130 on an inner surface that faces inward toward the header member 122 (generally toward a center of the frame 104). The cover member 132 may be engaged with and may be fixed to the core frame member 130 with one or more (e.g., three) rails 144 that are received in corresponding slits, kerfs, grooves, etc. extending longitudinally along the core frame member 130. As such, the cover member 132 may define an interior threshold area 146 of the frame 104, which is positioned along the first axis 111 between the core frame member 130 and the cladding member 134. Furthermore, the cover member 132 may include a weatherstrip engagement member 148 at an edge thereof. The weatherstrip engagement member may comprise an upturned edge, which is folded over itself to define a groove, channel, etc. for removably receiving a compressible weatherstrip 150. The panel 106 may compress and seal against the weatherstrip 150 when in the closed position as shown in FIG. 2. Furthermore, the cover member 132 may include a cladding engagement member 133, such as a flange that projects along the first axis 111 toward the first (i.e., exterior) side 114 of the frame 104. The cladding engagement member 133 may be slightly spaced apart along the third axis 113 from an underlying surface 135 of the core frame member 130.

The cladding member 134 may be thin and plate-like and may have substantially constant wall thickness. The cladding member 134 may be constructed from a metallic material, such as Aluminum alloy. Also, in some embodiments, the cladding member 134 may be an extruded part formed via an extrusion process. The cladding member 134 may be attached to the core frame member 130 and the cover member 132. For example, the cladding member 134 may include an inner area 152 with a groove 154 that receives the cladding engagement member 133 of the cover member 132. As such, a flange of the inner area 152 may be wedged and received in the gap between the cladding engagement member 133 and the underlying surface 135 of the core frame member 130. In some embodiments, a seal, a sealing member, etc. may be included at the joint between the cladding engagement member 133 of the cover member 132 and the interior of the groove 154. For example, the cladding engagement member 133 may include one or more compressible and resiliently deformable wings 131. The wings 131 may be formed of a polymeric material that may compress and seal against the cladding member 134 to provide a seal against water intrusion. Additionally, the cladding member 134 may include an outer area 156 that extends over the opposite outer surface of the core frame member 130. The outer area 156 may include a core engagement member 158, such as an upturned edge that is received within a corresponding groove, kerf, channel, etc. of the core frame member 130. Accordingly, the cladding member 134 may engage (i.e., grip, clamp onto, etc.) both inner and outer sides of the core frame member 130 and may simultaneously engage the cover member 132 for robust attachment within the frame 104. The cladding member 134 may further include a nose 160 that is extended from and that projects along the first axis 111 from the core frame member 130. The nose 160 may define a terminal exterior surface 162 of the frame. Also, an enclosed cladding cavity 201 may be included within the nose 160. Furthermore, the cladding member 134 may include a fin 166 (i.e., nail fin), such as a flat flange that projects along the third axis 113 from the core frame member 130.

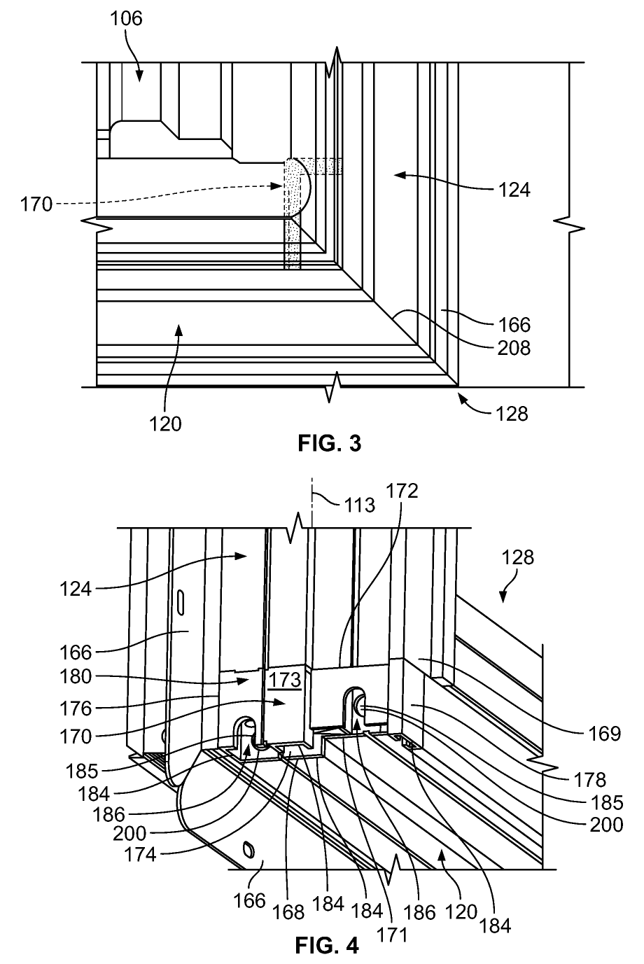

As shown in FIGS. 3 and 4, the first jamb 124 may be constructed similarly to the sill member 120. Furthermore, the header member 122 and the second jamb 126 may be constructed similarly to the sill member 120 shown in FIG. 2. The first and second jambs 124, 126 may be attached to respective ends of the sill member 120 and header member 122 to define plural (e.g., four) corners 128 (i.e., corner joints 128) of the frame 104. One such corner 128 (e.g., the attachment of the sill member 120 and the first jamb 124) is illustrated in detail in FIGS. 3-8 and will be discussed in detail below. It will be appreciated that at least one (e.g., all) of the three other corners 128 of the fenestration unit 102 may have similar features.

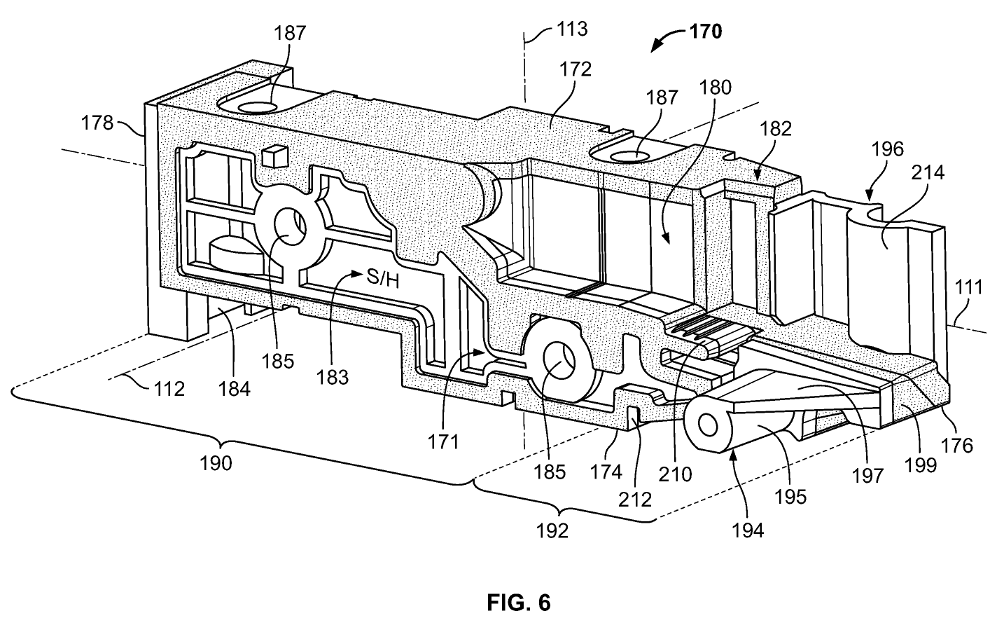

As shown, the frame 104 of the fenestration unit 102 may include at least one corner member 170. An example corner member 170 is shown in isolation in FIG. 6. The corner member 170 may be provided at the corner 128 of the frame 104 and may be attached and, in selected areas, sealed to the sill member 120 and the first jamb 124. It will be appreciated that the other three corners 128 of the frame may include a corresponding corner member 170 for joining the sill member 120 and the second jamb 126, for joining the first jamb 124 and the header member 122, and/or for joining the second jamb 126 and the header member 122. It will be appreciated that the corner member 170 may be configured for different corner joinery of additional fenestration units 102. For example, features of the corner member 170 of the present disclosure may be configured for a corner of the panel 106 of the fenestration unit 102.

As shown in FIG. 6, the corner member 170 may be generally block-shaped and may be elongated along the first axis 111 between an exterior end 176 and an interior end 178 thereof. The corner member 170 may include a first face 171, which is nonplanar and generally faces along the second axis 112 toward a longitudinal end 168 of the sill member 120 (FIGS. 4, 6, and 7). The corner member 170 may also include a second face 172, which is nonplanar and generally faces along the third axis 113 toward a longitudinal end 169 of the first jamb 124 (FIG. 4). The corner member 170 may further include a third face 173 (FIG. 4), which faces away from the sill member 120 along the second axis 112, and a fourth face 174 (FIG. 4), which faces away from the first jamb 124 along the third axis 113.

A majority of the corner member 170 may be defined by a monolithic, unitary, single-piece block having different regions that are made of different materials. The corner member 170 may include a base 180 and a deformable member 182, which covers over selected areas of the base 180. The deformable member 182 may partially cover, overlay, layer over, etc. the base 180. The deformable member 182 may cover over portions of the first face 171. The deformable member 182 may cover over portions of the second face 172. The covered portions that include the deformable member 182 may be sized and shaped for engaging and deforming against the respective elongate member to which the corner member 170 is attached. Specifically, areas of the deformable member 182 on the first face 171 may be sized, shaped, and otherwise configured for engaging and deforming resiliently against the sill member 120, and areas of the deformable member 182 on the second face 172 may be sized, shaped, and otherwise configured for engaged and deforming resiliently against the first jamb 124.

As shown in FIGS. 4 and 6, the base 180 may include a plurality of rigid, stiff, and strong walls 184. The walls 184 may have a selected wall-thickness that may be substantially constant throughout. The walls 184 may be spaced apart to define a plurality of pockets 186 that are open at the fourth face 174 and that are recessed inward along the third axis 113. The walls 184 may be interconnected for robust and high-strength support at the corner 128 of the frame 104. At least one or more of the plurality of the walls 184 may define portions of the first face 171 as will be discussed in greater detail below. Furthermore, at least one of the walls 184 may define portions of the second face 172. The base 180 may further include one or more apertures, such as first openings 185 extending therethrough along the second axis 112 from the third face 173 to the first face 171. The base 180 may include additional apertures, such as second openings 187 extending along the third axis 113 through the second face 172. The base 180 may also include at least one alphanumeric symbol 183, such as a symbol that is marked, inscribed, raised, or otherwise included on the first face 171. The symbol 183 may be a “S/H” symbol as shown to indicate the first face 171 is intended for mating against the sill member 120 (or against the header member 122); however, it will be appreciated that the symbol 183 may vary from the illustrated embodiment without departing from the scope of the present disclosure. In some embodiments, the walls 184 of the base 180 may be formed of acrylonitrile butadiene styrene (ABS). In additional embodiments, the walls 184 of the base 180 may be formed of a composite material (e.g., a composite formed of nylon and glass (i.e., glass-filled nylon)).

The deformable member 182 may include an external layer of material that is compressible and resiliently deformable. Thus, the base 180 may be considerably more rigid than the deformable member 182. The deformable member 182 may be layered on the base 180 in selected areas and may be layered at a substantially constant thickness (measured normal to the underlying surface of the base 180). The deformable member 182 may cover portions of the first face 171. For example, the deformable member 182 may border portions of the first face 171, and the base 180 may be exposed surrounding the first openings 185. As such, both the deformable member 182 and the base 180 may cooperatively define the first face 171. The deformable member 182 may define a majority of the second face 172 with the base 180 exposed surrounding the second openings 187 on the second face 172.

The deformable member 182 may be constructed of a resiliently deformable polymer in some embodiments. For example, the deformable member 182 may be made of thermoplastic vulcanizate (TPV) material. In some embodiments, the deformable member 182 may be molded, and may be formed via an injection molding process. Additionally, in some embodiments, the corner member 170 may be molded as a monolithic and unitary part wherein the deformable member 182 and the base 180 are formed in a single process, such as a co-molding operation. Thus, materials for both the base 180 and the deformable member 182 may be provided in a single mold cavity, the materials may be shaped, formed, and cured together to define the corner member 170.

As shown in FIGS. 4-8, the corner member 170 may be shaped, sized, and configured for fitting to, engaging, attaching, and/or sealing to the sill member 120 and the first jamb 124. As represented in FIGS. 6, 7, and 8, the corner member 170 may include a core frame engagement region 190 extending from the interior end 178 and along the first axis 111. The corner member 170 may also include a cladding engagement region 192 extending from the exterior end 176 and along the first axis 111. It will be appreciated that the first face 171 and the second face 172 may both define respective portions of the core frame engagement region 190. Likewise, it will be appreciated that the first face 171 and the second face 172 may both define respective portions of the cladding engagement region 192.

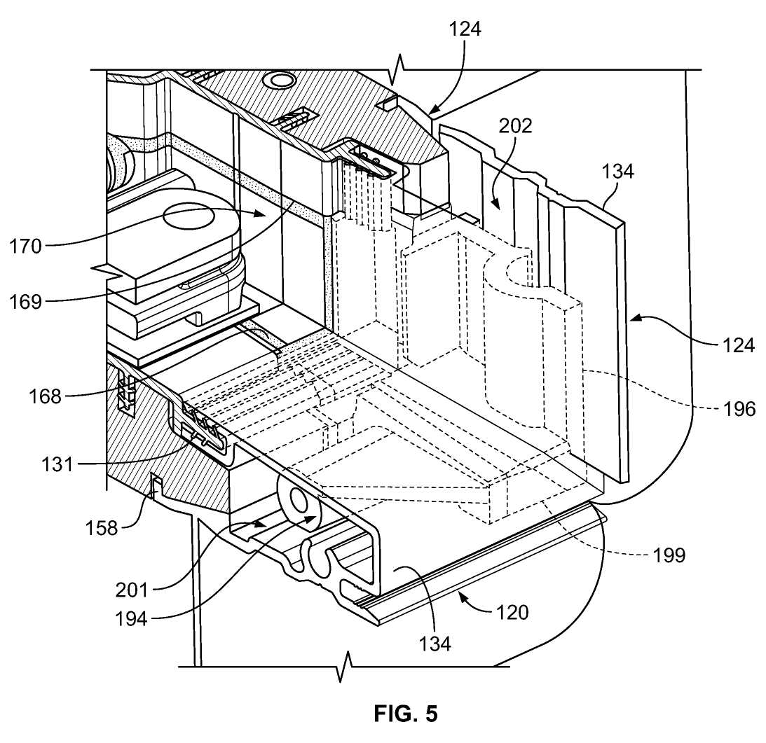

The core frame engagement region 190 may include the first openings 185 and the second openings 187. When attached, respective fasteners 200 (FIG. 4), such as threaded bolts, may extend through the openings 185, 187 to fixedly attach the corner member 170 to the core frame member 130 of the sill member 120 and the first jamb 124. Also, the core frame engagement region 190 may include a plurality of flat, planar areas that may be pressed against opposing flat, planar surfaces of the core frame members 130 of the sill member 120 and first jamb 124, respectively. These flat surfaces of the first face 171 at the core frame engagement region 190 may be normal to the second axis 112, and the opposing surfaces of the longitudinal end 168 of the sill member 120 may also be normal to the second axis 112. Specifically, as shown in FIG. 5, the core frame member 130 and cover member 132 may define portions of the longitudinal end 168 of the sill member 120, which are disposed normal to the second axis 112. Similarly, the second face 172 at the core frame engagement region 190 may be normal to the third axis 113, and the opposing surfaces of the longitudinal end 169 may also be normal to the third axis 113. These abutting surfaces may define respective butt joints. Also, the deformable member 182 at these butt joints may compress between the respective elongate member and the underlying base 180, thereby defining respective seals that limit moisture intrusion.

Referring to FIG. 6, additional features of the corner member 170 will be discussed. As shown, the cladding engagement region 192 of the corner member 170 may include a first projection 194, which projects from the first face 171 along the second axis 112 at the exterior end 176, and a second projection 196, which projects from the second face 172 along the third axis 113 at the exterior end 176.

The first projection 194 may include a press member 161 comprising a cylindrical post 195 and a flange 197. The flange 197 may be tapered so as to gradually reduce in width as the flange 197 projects along the second axis 112 from the first face 171. The post 195 and the flange 197 may be defined by the base 180 of the corner member 170 and, thus, may be substantially rigid in contrast to the deformable member 182.

The second projection 196 may include a wall 214 that has a substantially constant wall-thickness. The wall 214 may include planar portions as well as contoured portions, which may correspond to planar and contoured inner surfaces of the cladding member 134 of the first jamb 124. The second projection 196 may be defined by the base 180 of the corner member 170 and, thus, may be substantially rigid in contrast to the deformable member 182.

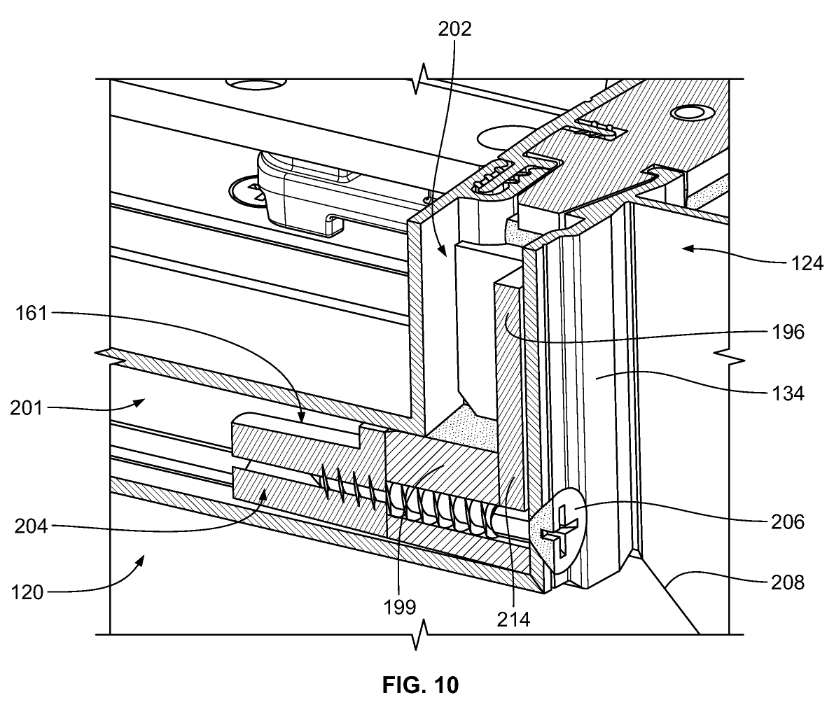

Also, the corner member 170 may include an expansion plug 199. The expansion plug 199 may be defined by the deformable member 182 and, thus, may be resilient and compressible. The expansion plug 199 may define the exterior end 176 of the corner member 170, including that of the first face 171, and the first projection 194 may project along the second axis 112 from the expansion plug 199. As shown in FIG. 10, the expansion plug 199 may be disposed between the press member 161 and the second projection 196 along the second axis 112. In some embodiments, the expansion plug 199 may attach the post 195 and flange 197 to the first face 171.

Furthermore, as shown in FIG. 10, the corner member 170 of the frame 104 may include a selector feature 204 for selectively adjusting the expansion plug 199. The selector feature 204 may include the press member 161 as well as a selector member 206. The selector member 206 may be a threaded bolt or screw and may extend from an exterior side of the cladding member 134 of the first jamb 124, through the expansion plug 199, to threadably attach to the press member 161. Accordingly, a user may selectively rotate the selector member 206 to gradually advance the press member 161 toward the expansion plug 199.

Furthermore, the corner member 170 may include a cladding engagement member 210 (FIG. 6). The cladding engagement member 210 may correspond in shape, location, etc. to that of the cladding engagement member 133 (FIG. 2) of the cover member 132 of the frame 104.

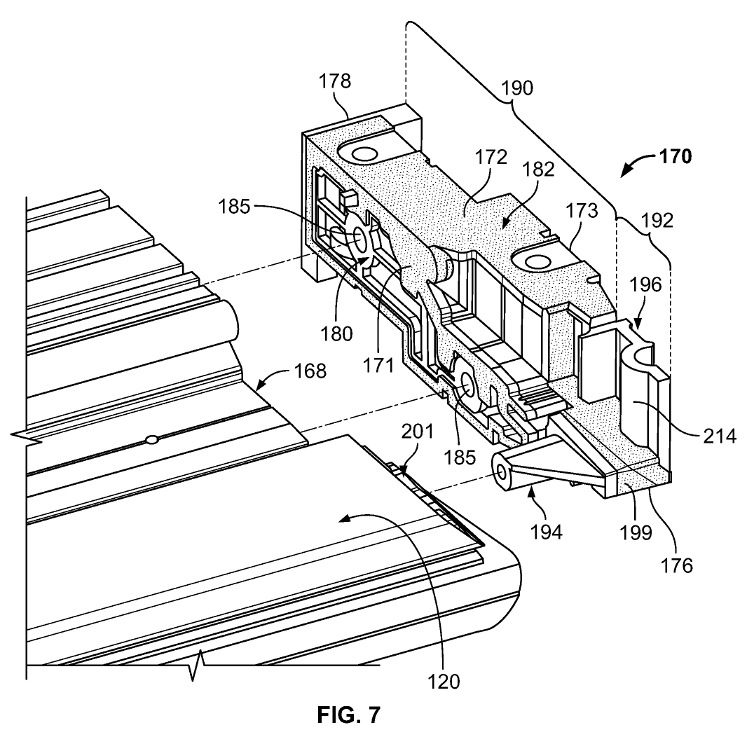

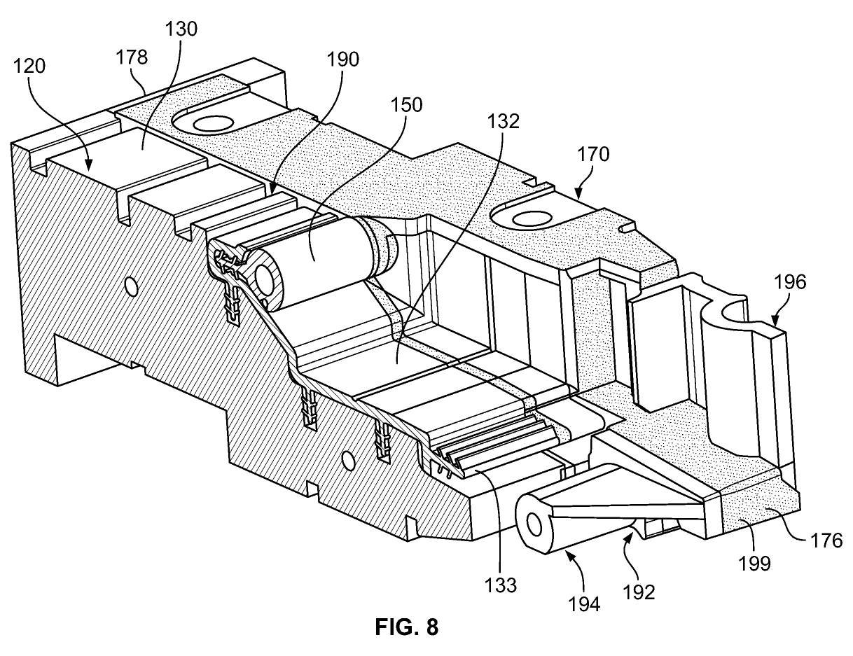

During assembly of the frame 104, the corner member 170 may attach to the sill member 120 as shown in FIGS. 7 and 8. Fasteners may extend through the first openings 185 and into the core frame member 130. The deformable member 182 of the first face 171 may compress and seal (i.e., define one or more seals, sealed areas of the frame 104, etc.) between the base 180 and the core frame member 130. Also, the first projection 194 may be received in the cavity 201 of the cladding member 134 of the sill member 120 (FIG. 5).

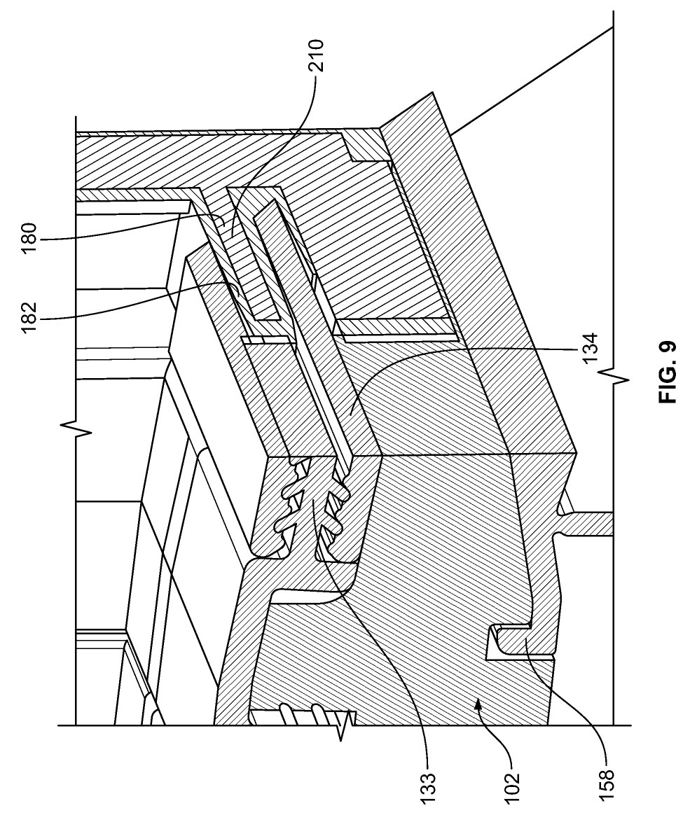

As shown in FIGS. 8 and 9, the cladding engagement member 210 may be substantially aligned along the second axis 112 with the cladding engagement member 133 of the sill member 120. Accordingly, the cladding member 134 of the sill member 120 may engage, grip, clamp around both the cladding engagement member 133 and the cladding engagement member 210 of the corner member 170. In other words, the cladding engagement member 210 and the cladding engagement member 133 may cooperatively define a cladding engagement feature for engaging with the same cladding member 134. Moreover, the corner member 170 may also include a groove 212 for the engagement member 158 of the cladding member 134, similar to the engagement shown in FIG. 2.

The first jamb 124 may also be attached with fasteners extending through the second openings 187 and into the core frame member 130 of the first jamb 124. The second projection 196 may be received in a second cavity 202 of the cladding member 134 of the first jamb 124.

As shown in FIGS. 3 and 10, the cladding members 134 may meet edge-to-edge to cooperatively define a miter joint 208 (e.g., a forty-five degree (45°) miter joint 208). Stated differently, the longitudinal ends 168, 169 of the cladding members 134 may be disposed at respective forty-five degree (45°) angles to the longitudinal axis of the sill member 120 and the first jamb 124, respectively, to define the miter joint 208 at the corner 128.

Moreover, during manufacture of the fenestration unit 102, the selector feature 204 may be used to adjust the internal expansion plug 199 from outside the frame 104. By rotating the selector member 206 (e.g., using a screwdriver or other implement), the press member 161 may be advanced toward the expansion plug 199, and pressure against the plug 199 may be selectively varied. The plug 199 may compress and expand such that the outer profile of the plug 199 presses and seals against the interior of the cavity 201 and/or the cavity 202 of the cladding members 134.

Additional corners 128 of the fenestration unit 102 may be similarly assembled with respective corner members 170. These additional corner members 170 may be adjusted to expand the respective plugs 199. Accordingly, the frame 104 of the present disclosure may be strong and robust. The corner members 170 may provide robust support at the respective corners 128 of the frame 104. Also, the deformable member 182 may provide useful seals within the frame 104, and manufacturing of the fenestration unit 102 may be highly efficient because of these features. The process may be useful for high-volume manufacturing because it is highly repeatable.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the present disclosure as long as such an interchange does not contradict the claim language and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fenestration unit frame comprising:
a first elongate member;
a second elongate member;
a corner member that is attached to the first elongate member and the second elongate member at a corner of the fenestration unit frame; and
the corner member including a base and a deformable member that are integrally attached, the deformable member overlying at least part of the base, the base being more rigid than the deformable member, and the deformable member being compressed between the rigid base and at least one of the first elongate member and the second elongate member to provide a seal therebetween.

2. The fenestration unit frame of claim 1, wherein the corner member includes a first face that faces the first elongate member and a second face that faces the second elongate member, the first face defined cooperatively by the base and the deformable member, the second face defined cooperatively by the base and the deformable member.

3. The fenestration unit frame of claim 1, wherein the corner member includes an expansion plug and a selector feature, the expansion plug received within a cavity of the first elongate member, and the selector feature configured to selectively vary pressure against the expansion plug for substantially sealing within the cavity.

4. The fenestration unit frame of claim 3, wherein the selector feature includes a press member and a selector member, the selector member supported for movement relative to the first elongate member to selectively adjust position of the press member and to thereby selectively vary pressure against the expansion plug.

5. The fenestration unit frame of claim 1, wherein the first elongate member includes a core frame member and a cladding member attached thereto.

6. The fenestration unit frame of claim 5, wherein the first elongate member includes a cover member that at least partly covers the core frame member, the cover member and the corner member cooperatively defining a cladding engagement feature, the cladding member engaged with the cladding engagement feature.

7. The fenestration unit frame of claim 5, wherein the corner member includes an expansion plug and a selector feature, the expansion plug received within a cavity of the cladding member, and the selector feature configured to selectively vary pressure against the expansion plug for substantially sealing within the cavity.

8. The fenestration unit frame of claim 1, wherein the second elongate member is configured to support a casement window panel for rotational movement between a closed position and an open position relative to the frame.

9. The fenestration unit frame of claim 1, wherein the corner member includes a first face that faces the first elongate member and a second face that faces the second elongate member, wherein the first elongate member includes a first cladding member that defines a first cavity therein, wherein the second elongate member includes a second cladding member that defines a second cavity therein, and wherein the first face of the corner member includes a first projection received in the first cavity and the second face of the corner member includes a second projection received in the second cavity.

10. The fenestration unit frame of claim 1, wherein the base is made of one of acrylonitrile butadiene styrene (ABS) and a composite of nylon and glass.

11. The fenestration unit frame of claim 1, wherein the deformable member is made of thermoplastic vulcanizate (TPV) material.

12. The fenestration unit frame of claim 1, wherein the first elongate member is elongated along a longitudinal axis, wherein the first elongate member includes at least one first surface that is substantially planar and perpendicular to the longitudinal axis, and wherein the corner member includes a first face that opposes the at least one first surface, the deformable member being compressed against the at least one first surface.

13. A method of manufacturing a fenestration unit frame comprising:
providing a corner member including a base and a deformable member that are integrally attached, the deformable member overlying at least part of the base, the base being more rigid than the deformable member;
attaching the corner member to a first elongate member and to a second elongate member at a corner of the fenestration unit frame; and
compressing the deformable member between the rigid base and at least one of the first elongate member and the second elongate member to provide a seal therebetween.

14. The method of claim 13, wherein providing the corner member includes co-molding the corner member.

15. The method of claim 13, wherein the corner member includes an expansion plug and a selector feature, and further comprising receiving the expansion plug within a cavity of the first elongate member and selectively varying pressure against the expansion plug by manipulating the selector feature for substantially sealing within the cavity.

16. The method of claim 13, wherein the first elongate member includes a core frame member and a cladding member attached thereto.

17. The method of claim 16, wherein the first elongate member includes a cover member that at least partly covers the core frame member, the cover member and the corner member cooperatively defining a cladding engagement feature, and further comprising engaging the cladding member with the cladding engagement feature.

18. The method of claim 16, wherein the corner member includes an expansion plug and a selector feature, further comprising receiving the expansion plug within a cavity of the cladding member, and further comprising selectively adjusting the selector feature to selectively vary pressure against the expansion plug for substantially sealing the expansion plug within the cavity.

19. The method of claim 13, wherein the corner member includes a first face configured to face the first elongate member and a second face configured to face the second elongate member, wherein the first elongate member includes a first cladding member that defines a first cavity therein, wherein the second elongate member includes a second cladding member that defines a second cavity therein, and further comprising receiving a first projection of the first face in the first cavity and receiving a second projection of the second face in the second cavity.

20. A fenestration unit comprising:
a frame;
a panel supported within the frame;
the frame including a first elongate member with a first core frame member and a first cladding member, a second elongate member with a second core frame member and a second cladding member, and a corner member that is attached to the first elongate member and the second elongate member at a corner of the frame;
the corner member including a base and a deformable member that are integrally attached, the deformable member overlying at least part of the base on a first face of the corner member and on a second face of the corner member, the base being more rigid than the deformable member, the deformable member at the first face being compressed between the rigid base and the first core frame member to provide a first seal therebetween, the deformable member at the second face being compressed between the rigid base and the second core frame member to provide a second seal therebetween;
the corner member including an expansion plug defined by the deformable member and a selector feature defined by the base, the expansion plug received within a first cavity of the first cladding member, and the selector feature configured to selectively vary pressure against the expansion plug for substantially sealing within the first cavity; and
the corner member including a projection that is received in a second cavity of the second cladding member.
